(19) United States
(12) Patent Application Publication
(10) Pub. No.: US 2016/0168394 A1
(43) Pub. Date: Jun. 16, 2016

(54) Intumescent Mesh Coating

(71) Applicant: United States Mineral Products Company, Stanhope, NJ (US)

(72) Inventor: Robert Paul Kreh, Middle River, MD (US)

(73) Assignee: United States Mineral Products Company, Stanhope, NJ (US)

(21) Appl. No.: 14/604,978

(22) Filed: Jan. 26, 2015

Related U.S. Application Data
(63) Continuation-in-part of application No. 14/568,212, filed on Dec. 12, 2014.

(51) Int. Cl. C09D 5/18; C09D 163/00

(52) U.S. Cl. CPC C09D 5/185; C09D 163/00

(57) ABSTRACT

The present disclosure relates to intumescent fireproofing coatings and methods to apply these coatings. In particular, the disclosure relates to epoxy-based intumescent fireproofing coatings and methods of applying these coating having a mesh reinforcement.

### CROSS REFERENCE TO RELATED APPLICATIONS

The present application is a continuation-in-part of co-pending U.S. patent application Ser. No. 14/568,212 filed Dec. 12, 2014. This application claims priority benefit to the foregoing application and hereby incorporates by reference the foregoing application in its entirety as part of the present disclosure.

### FIELD OF THE TECHNOLOGY

The present disclosure relates to intumescent fireproofing coatings and methods to apply these coatings. In particular, the disclosure relates to epoxy-based intumescent fireproofing coatings and methods of applying these coatings having a mesh reinforcement.

### BACKGROUND

Fireproofing is used in a variety of construction settings to provide fire retardation and/or thermal protection in the event of a fire. A variety of combustible or heat sensitive substrates are protected by fireproofing. Examples are wood, foam insulation, structural steel, walls and floors.

One type of fireproofing is an intumescent coating wherein, during a fire, the coating swells and forms a fire-stable insulating foam “char.” The intumescent coating can be based on a variety of different resin types, such as polyvinylacetate, polyacrylate, polyurethanes and epoxy resins. Epoxy-based intumescent coatings are often employed to provide superior stability to environmental challenges, such as rain, salt water, temperature extremes and physical abuse. In addition, epoxy-based intumescent coatings form strong chars during a fire, providing resistance to very high temperatures, flame erosion and char sagging. For example, these coatings can provide fireproof protection for fires with fast, extreme temperature rises and strong, eroding flames (e.g., the UL 1709 standard and “jet fire”). These types of fires have been known to occur at petrochemical plants, gas storage facilities and off-shore oil facilities. These coatings can also provide fireproof protection for milder fires fueled by cellulosics or plastics. Standard evaluation of fireproofing can be done using the ASTM E119 standard.

While epoxy-based intumescent coatings can form strong, durable chars, these chars can be brittle, leading to cracks and fissures within the char. If these defects widen and extend down to the substrate, the insulation can be compromised, resulting in a fast temperature rise of the substrate. This is especially problematic on round substrates and at “outer” edges of substrates. For example, intumescent coatings are prone to failure at the corners of rectangular substrates and on the tips of wide-flange columns or beams.

To address this problem, a common solution is the placement of high-temperature-resistant mesh within the epoxy coating. Examples of mesh materials include metal wire mesh, glass fiber mesh, sintered/pyrolyzed carbon fiber mesh and refractory mineral fiber mesh (e.g., basalt). The mesh is generally placed at a depth of ⅓-⅔ of the total thickness of the coating. During a fire, as char-splitting moves downward through the fireproofing toward the substrate, it can be halted by the mesh, preventing the lower char from splitting. A degree of insulation can be maintained at these char splits where the mesh is present.

As noted above, the mesh is usually placed in the middle of the fireproofing (e.g., at a ⅓-⅔ depth) to prevent direct exposure of the mesh to the heat. It is also placed in the middle to allow the upper, outer fireproofing to experience char growth unrestricted by the mesh. The char expansion underneath the mesh is generally less than that above the mesh.

U.S. Pat. No. 5,433,991, incorporated herein by reference in its entirety, describes traditional embedding of mesh installation in an epoxy fireproofing layer. By embedding the mesh, the mesh is adhered to and encapsulated into an epoxy-intumescent material. This avoids the introduction of “foreign” material, or a second fireproofing material, in contact with the mesh which could result in deleterious effects, such as delamination or slippage between layers either before or during a fire. Also, the introduction of two different chemistries within the fireproofing, or in contact with the mesh, can have adverse effects on curing and/or the chemical/physical reactions necessary for intumescence.

The typical procedure for applying an intumescent fireproofing coating having a mesh is known. After application of a lower layer of uncured epoxy material, a period of time is allowed to pass, during which the lower layer “gels.” The mesh is applied while the viscosity is high enough such that the mesh can be pushed into the lower layer of epoxy material without excessive deformation of this layer or mesh. At the same time, the viscosity is low enough such that the mesh will penetrate the partially-cured layer. Ensuring the proper timing of this step is burdensome to the applicator and varies with the materials used and the environmental conditions. Sufficient embedment and leveling of the surface is also needed. This is generally accomplished by rolling the mesh/epoxy surface with a solvent-soaked “painting” roller. Solvent is used to prevent the sticking of the partially-cured epoxy to the surface of the roller. A highly volatile (and flammable) solvent, such as acetone, is used so that it will evaporate prior to application of the next epoxy layer (usually several hours later). Managing this timing presents an additional burden on the applicator. The release of solvent vapors is also undesirable due to potentially adverse effects to worker health and to the environment.

The present disclosure relates to intumescent fireproofing coating compositions, kits, and methods of applying the same. The coating compositions are safe, environmentally friendly, less cumbersome to apply, and perform as well as, or better, than known coatings.

### SUMMARY

The present disclosure relates to intumescent fireproofing coating compositions, kits, and methods of applying the same.

In one embodiment, the present disclosure relates to an intumescent composition having a first epoxy resin layer having a top side and a bottom side, and containing a first intumescent material, an adhesive contacting the top side (the side away from the substrate) and a mesh, which is in contact with a second epoxy resin layer containing a second intumescent material, wherein the first and second epoxy resin layers containing intumescent materials swell as a result of heat exposure. The intumescent composition can advantageously be applied as a fireproofing coating to a substrate. It is understood that the first and second intumescent materials can be the same or different. It is understood that the first and second epoxy resins can be the same or different. It is understood that the layers referred to above can be comprised of sub-layers, each being identical or different and may contain one or more mesh layers.

In another embodiment, the present disclosure relates to a method of applying a first epoxy resin layer containing a first intumescent material to a substrate, applying an adhesive to the first epoxy resin layer, applying a mesh to this adhesive-coated surface, and applying a second resin layer containing a second intumescent material over the mesh to form an intumescent composition, wherein the first and second epoxy resin layers containing intumescent materials swell as a result of heat exposure. It is understood that the first and second intumescent materials can be the same or different. It is understood that the first and second epoxy resins can be the same or different. It is understood that the layers referred to above can be comprised of sub-layers, each being identical or different and may contain one or more mesh layers.

In another embodiment, the present disclosure relates to a method of applying a first epoxy resin layer containing a first intumescent material to a substrate, applying an adhesive to a mesh, applying the mesh to the first epoxy resin/intumescent layer, and applying a second resin layer containing a second intumescent material on top of the mesh to form an intumescent composition, wherein the first and second epoxy resin layers with intumescent materials, swell as a result of heat exposure. It is understood that the first and second intumescent materials can be the same or different. It is understood that the first and second epoxy resins can be the same or different. It is understood that the layers referred to above can be comprised of sub-layers, each being identical or different and may contain one or more mesh layers.

Additional features, functions and benefits associated with the present disclosure will be apparent from the detailed description which follows.

### DETAILED DESCRIPTION

It is one object of the present disclosure to provide a straightforward and safe method for the application of protective mesh within an epoxy intumescent coating. The application of the protective mesh can be accomplished using an adhesive, such as using a thin layer of adhesive by which to hold the mesh in place on a first epoxy resin/intumescent layer until application of the next epoxy resin/intumescent layer. The mesh attachment can be carried out any time between application of the first layer (e.g., lower epoxy-intumescent layer), or preferably after a sufficient curing of the first layer occurs, or more preferably just before application of the second layer (e.g., upper epoxy-intumescent layer). By attaching the mesh using an adhesive, the need to properly time the mesh embedment into the first epoxy-intumescent layer is significantly reduced or eliminated, as well as the other problems associated with embedding the mesh.

As used herein the term “intumescent composition” refers to a composition that contains an intumescent material.

As used herein the term “layer” means a thickness of epoxy resin and intumescent material having a homogeneous composition that is separately formed from other layers. Each of the layers of the multilayer composition of the present disclosure may have the same or different widths and thicknesses. The epoxy resin and intumescent material of the different layers may be identical or different.

As used herein the term “intumescent material” means a material that expands, foams, or swells when exposed to a sufficient amount of thermal energy.

In one embodiment, the present disclosure relates to an intumescent composition having a first epoxy resin layer having a top side and a bottom side, and containing intumescent material, a mesh in contact with the top side of the first resin layer, an adhesive in contact with the top side of the first resin layer and mesh, and a second epoxy resin layer in contact with the top side of the mesh, and containing an intumescent material, wherein the first and second epoxy resin/intumescent layers swell as a result of heat exposure.

The first epoxy resin/intumescent layer can be applied to a substrate in need of fire retardation and/or thermal protection in the event of a fire. The thickness of this first epoxy resin/intumescent layer may vary depending on the substrate, the resin, the intumescent material and the degree of protection desired. In one embodiment, this first layer can have a dry film thickness between about 0.5 mm and about 20 mm. More particularly, the first resin layer can have a dry film thickness between about 1 mm and about 10 mm, or about 2 mm and about 6 mm. In some embodiments, the dry film thickness can be about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm and 20 mm. These values can also be used to define a range of thicknesses, e.g., about 2 mm to about 10 mm.

The thickness of the first epoxy resin/intumescent layer can be consistent throughout the composition. For example, the variation of the thickness of the first resin layer over a substrate or a substrate section can vary less than about 5% or about 10%. In some embodiments, this first layer can also have an inconsistent thickness. Similarly, this first layer can be continuous over a substrate or a substrate section. In some embodiments, the first resin layer can also be non-continuous. For example, a first epoxy resin/intumescent layer on a flat surface can be continuous, have a consistent thickness, or both. In another example, this first resin layer on an uneven surface can be non-continuous, have a variable thickness, or both. The second epoxy resin/intumescent layer can also have the same thickness variations and continuous features.

The epoxy resin used for the first and second epoxy resin/intumescent layers can be independently selected from resins known to one skilled in the art that are used in epoxy intumescent compositions. In particular, the epoxy resin used in the first and second layers can be independently selected from the types known to those skilled in the art. In a preferred embodiment, the epoxy resin is two part, with some curing taking place after it is applied to a substrate. One part has epoxy functionality, while the other part reacts with said epoxy. This second part is often referred to as a hardener. In a preferred embodiment, the hardener is comprised of one or more chemicals with amine functionality. In a preferred embodiment, the epoxy contains one or more chemicals for viscosity reduction.

The first and second resin layers can also have the same epoxy resin. In one embodiment, the first and second epoxy resin/intumescent layers can also contain different resins.

The amount of first resin layer in the composition can vary depending on the substrate, the resin, the intumescent material and the degree of protection desired. In one embodiment, the amount of first resin layer in the composition can be between about 10 wt % and about 90 wt %. More particularly, the amount of first resin layer in the composition can be between about 30 wt % and 70 wt %. In some embodiments, the amount of the first resin layer can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %.

Likewise, the amount of second resin layer in the composition can vary depending on the substrate, the resin, the intumescent material and the degree of protection desired. In one embodiment, the amount of second resin layer in the composition can be between about 10 wt % and about 90 wt %. More particularly, the amount of second resin layer in the composition can be between about 30 wt % and 70 wt %. In some embodiments, the amount of the second resin layer can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %. It is understood that the layers referred to above can be comprised of sub-layers, each being identical or different and may contain one or more mesh layers.

The first and second resin layers each independently contain an intumescent material. The intumescent material imparts on the resultant intumescent resin layer, and the composition, with the ability to swell when exposed to heat. The intumescent materials can be independently selected from intumescent materials known in the art, and in particular, the group consisting of ammonium polyphosphate, melamine pyrophosphate, ethylenediamine phosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides, tris(dimethylaminomethyl)phenol and similar chemicals.

The amount of intumescent material in either the first or second resin layer can vary depending on the substrate, the resin, the intumescent material and the degree of protection desired. In one embodiment, the amount of intumescent material independently in either the first or second resin layer can be between about 20 wt % and 80 wt %. More particularly, the amount of intumescent material independently in either the first or second resin layer can be between about 30 wt % and 70 wt %. In some embodiments, the amount of the intumescent material independently in either layer can be about 5, 10, 15, 20, 25, 30, 35, 40, 45, 50, 55, 60, 65, 70, 75 and 80 wt %. These values can also be used to define a range of amounts, e.g., about 5 wt % to about 35 wt %.

Suitable resin-intumescent materials (i.e., a resin containing an intumescent material) are known in the art. For example, epoxy-intumescent materials are known in the art, such as NanoChar, CHARTEK™ VII, Pyroclad X1, Pittchar and Firetex M90. These suitable resin-intumescent materials typically consist of a two-part system. For instance, a two part epoxy system is described. A first part being an epoxy resin (binder) plus additives. A second part being a hardener plus additives. The two parts are mixed and used to coat the substrate. In some embodiments, the first resin layer containing a first intumescent material, the second resin layer containing a second intumescent material, or both are selected from these suitable resin-intumescent materials. Additional examples of suitable resin-intumescent materials are described in U.S. Pat. No. 6,069,812 and U.S. Pat. No. 5,070,119, each incorporated herein by reference in its entirety.

The first and second resin layers can be applied by known techniques. In particular, the first and second resin layers can be applied by spray, trowel, brush and by similar means. In some instances, the suitable resin-intumescent material is applied and cures after application. The cure time can vary. Typical cures times are between about 1 hr and 24 hr. For high-viscosity compositions, fast curing resin layers (e.g., between about 1 hr and 6 hr) or when applying a thick resin layer (e.g., between about 3 mm and 7 mm), the application can employ heated, plural systems wherein the parts are mixed in-line prior to being applied.

In some applications, a solvent can also be added to one or both of the parts being mixed, or to the mixed product. The mixed product/solvent composition can then be spray-applied, such as through a conventional “single-leg” paint sprayer or other spray-methods known to those skilled in the art of “paint spraying”. A preferred method is airless spray. Preferred solvents are organic chemicals and can contain aliphatic, aromatic, ketone, ether, and/or hydroxyl functionality.

A mesh can be applied to the resin layer(s) to reinforce the composition. The use of a mesh can provide reinforcing of the char once it starts to form. The mesh can reduce the chance that the coating will crack of fissure. Fissures reduce the protection provided by the coating because a fissure allows heat to more readily reach the substrate. The use of a mesh reduces the depth, length, width or combinations thereof for any fissures formed.

The mesh can be selected from meshes known to one skilled in the art that are used in intumescent compositions. The mesh can be selected from known high-temperature-stable meshes and can be made from fibers/strands of metal, glass, oxidized carbon or refractory inorganics. Examples are Zoltek PX30FS08X4-COAT (Panex 30: Scrim Fabric 8×4 Coated) mesh, HK-1 from International Paint, and IR-107 available from Intumescents Associates Group.

The mesh can be made using fibrous materials, such as high-temperature-stable polymers, class, inorganic oxides, carbon, and graphite fibers. Fibers containing carbides, such as silicon carbide or titanium carbide; borides, such as titanium diborides; oxides, such as alumina or silica; or ceramic can be used. The fibers can be used in the form of monofilaments, multifilaments, tows or yarns. In different embodiments, the mesh can be contain high temperature fibers, a welded wire mesh, or combinations thereof.

The amount and properties of the mesh such as density, size of fibers, flexibility, and ability to retain tensile strength at high temperatures are those known to those skilled in the art, represented by the Underwriters Laboratory 1709 designs for Carboline Type 440, Thermo-Lag 2000, Thermo-Lag 3000, Pitt-Char XP, Pitt-char XP2, Firetex M90, Firetex M93, Chartek 4, Chartek 7, and Chartek 1709.

An adhesive can be used to hold, or secure, the mesh onto the first resin layer. The adhesive can be an adhesive known to one skilled in the art of bonding together porous and/or non-porous surfaces. In one embodiment, the adhesive can be selected from the following types (or chemistries) consisting of rubbery polymers (often dissolved in organic solvents for ease of application), water-based latex polymers, cyanoacrylates, polyurethanes, and silicones. In one embodiment, the adhesive can be a rubbery solid. The rubbery solid can be soluble in an organic solvent. In another embodiment, the adhesive is a polymer. The polymer can be capable of being supplied as a water-based emulsion.

In one embodiment, the adhesive is a one-part system. A one-part system is faster and easier to apply. A multiple part system, e.g., two-part system, is slower and more difficult to apply. For example, in most multiple part systems the parts must be combined shortly before application. In some embodiments, the one-part adhesive has a different chemical make-up as compared to the epoxy resins used for the intumescing layers. The epoxy resins are generally two-part, curing systems. Surprisingly, in these embodiments, in spite of said differing chemistries, the use of one-part adhesives in the compositions of the present disclosure performed well before and during exposure to high temperatures.

The length of time it takes for the adhesive to initiate or start to effectively hold the mesh in place (e.g., without being held in place by the applicator or other means) is relatively short. For example, the adhesive can initiate holding the mesh in place (e.g., on the first resin layer) after about 1 second, about 2 seconds, about 5 seconds, about 10 seconds, about 30 seconds, about 1 minute, about 2 minutes, or for 5 minutes. These times can also be used to describe ranges of time it can take for the adhesive to initiate holding the mesh in place, such as from about 1 second to about 30 seconds, or any similar range.

The length of time the adhesive holds the mesh in place is sufficient to allow a second layer of resin material to be applied to the first mesh-resin layer with the mesh still in place. Preferably this time is greater than 30 seconds, more preferably greater than 60 seconds and more preferably greater than 5 minutes. In some embodiments, the adhesive can hold the mesh in place (e.g., on the first resin layer) for about 30 seconds, about 1 minute, about 2 minutes, about 5 minutes, about 10 minutes, about 30 minutes, or for about 1 hour or more. These times can also be used to describe ranges of time the mesh can be held in place, such as from about 30 seconds to about 30 minutes, or any similar range.

The adhesive can be applied by known techniques. In one embodiment, the adhesive can be spray-applied. The adhesive can be applied to certain sections of the mesh and other sections of the mesh can have no adhesive applied. A non-continuous layer of adhesive can be applied to the mesh, first resin layer or both. For non-continuous adhesive layers, there can be some direct contact of adjacent resin layers, through or around the mesh.

The amount of adhesive used to hold or secure the mesh may vary. In one embodiment, the amount of adhesive in the composition is less than 1%. More particularly, the amount of adhesive in the composition can be less than 0.1%.

The thickness of the adhesive applied to the first resin layer (e.g., the adhesive layer) prior to the mesh application, or applied to the mesh (e.g., the adhesive is pre-applied to the mesh) or during the mesh application can vary. In particular, the thickness of the adhesive layer can be less than 20 mils, 15 mils, 10 mils, 8 mils, 5 mils, 3 mils, 2 mils or 1 mil. These values can also define a range of adhesive layer thickness, such as between about 1 mil and 3 mils.

The intumescent composition of the present disclosure can be used to protect a variety of substrates. In one embodiment, the intumescent composition of the present disclosure can be used to protect a substrate having edges or sides wherein the edges or sides are more difficult to protect using non-mesh containing intumescent compositions and, therefore, are more susceptible to damage from high temperature environments. The type of material to be protected can include metal, wood and foamed, solid polymeric materials or paper in need of a thermal barrier against the effects of overheating and/or burning. The metals can include aluminum, iron, and steel. The substrate to be protected can be in the form of an I-beam (e.g., steel I-beam), a wide flange column, a round column or a rectangular column. Substrates of larger area can also be protected. Examples are walls, ceilings, floors and insulated material.

The first, second or both resin layers can swell as a result of heat exposure. The degree swelling can vary depending on the level and rate of heat exposure and/or the composition of the layers substrate and the like.

The intumescent composition of the present disclosure can extend the time it takes for a substrate to reach its critical failure temperature. For example, the intumescent composition of the present disclosure can extend the time it takes for steel to reach its critical failure temperature (e.g., 550 degrees C.) under standard test conditions. In one embodiment, the intumescent composition of the present disclosure can result in the time it takes for a substrate to reach is critical failure temperature to be 15-300 minutes. Particular values are 30, 60, 75, 120, 150, or 240 minutes.

The present disclosure also relates to a method of applying an intumescent composition, as described herein, onto a substrate, the method comprising applying a first epoxy resin layer containing intumescent material to a substrate, applying an adhesive to the first epoxy resin layer, applying mesh to the first resin layer, wherein the mesh is affixed to the first layer with an adhesive, and applying a second epoxy resin/intumescent layer containing intumescent material to the mesh layer to form an intumescent composition, wherein the first and second intumescent materials swell as a result of heat exposure.

The first and second resin layers, and the adhesive, can be applied by known techniques. In particular, the first and second resin layers can be applied by spray, trowel, brush and by similar means. The adhesive can be applied by a roller, by a brush, or can be spray-applied.

The mesh can be applied by known techniques. In particular, the mesh can be applied manually or mechanically by pressing or holding the mesh in or onto the first resin layer after the adhesive is applied to the first layer or to the mesh. In one embodiment, the mesh can be applied without the use of a solvent to assist in attaching or embedding the mesh into the resin layer (e.g., the composition is solvent-free). The mesh can also be applied as separate pieces over the first resin layer. For example, the mesh can be applied as separate pieces around each tip of an I-beam or column.

Traditionally, the mesh is applied to the first epoxy resin/intumescent layer before or during the cure time. The mesh is contacted to this first layer and embedded into this layer. Embedding the mesh, however, is not trivial. The mesh must be embedded after the resin layer has hardened or cured enough to accept the mesh and hold the mesh in place after embedding. Said hardening can occur via solvent evaporation, cooling, curing, viscosity increase due to the absence of movement (versus the reduced viscosity generated during spray), and the like. That is, the viscosity must be low enough to allow the mesh to penetrate the un-hardened or partially-hardened layer. The mesh cannot be embedded after the resin layer has cured too much such that the force applied to embed the mesh damages the resin layer, results in insufficient embedding, weak attachment or is too burdensome for the applicator. At the same time, the viscosity must be high enough such to allow the mesh to be pushed into the epoxy material without excessive deformation of either the layer or the mesh. Because hardening times for different suitable resin-intumescent materials vary, correct application of the mesh is often incorrect or non-ideal. The present disclosure provides a method, and resulting composition, that eliminates or reduces these issues. The methods, and compositions, of the present disclosure are applicable to substantially all suitable epoxy resin-intumescent materials regardless of rate of hardening.

The adhesive, mesh, or both can be applied before the first epoxy resin/intumescent layer is substantially cured. The adhesive, mesh, or both can also be applied after this layer is substantially cured such that the mesh will not adhere to the resin layer in the absence of the adhesive. The adhesive, mesh or both can be applied immediately after the first resin layer is applied (or has sufficient viscosity to support such application), or after 1 minute, 2 minutes, 5 minutes, 10 minutes, 20 minutes, 30 minutes, 1 hour, 2 hours, 4 hours, 8 hours, 16 hours, 1 day, 2 days, 1 week, or longer. These times can also define a range of when the adhesive, mesh or both can be applied to the first resin layers, such as between 10 minutes and 1 week.

In other embodiments, the applied adhesive does not completely cover the epoxy layer to which it is affixed, such that the second resin layer can penetrate and contact the first resin layer, in between areas covered with adhesive.

The present disclosure also relates to another method of applying an intumescent composition as described herein onto a substrate, the method comprising applying a first epoxy resin layer containing intumescent material to a substrate, applying an adhesive to a mesh, applying the adhesive/mesh to the first epoxy resin/intumescent layer, and applying a second epoxy resin layer containing intumescent material to the adhesive layer to form an intumescent composition, wherein the intumescent materials swell as a result of heat exposure. Pre-applying the adhesive to the mesh would allow for the use of less adhesive and provide larger areas of direct contact between the first and second intumescent layers. It may, however, make the handling of the mesh more difficult.

Prior to the application of the intumescent composition of the present disclosure, the substrate can be primed with a primer (e.g., presenting a primed surface). The substrate can also be an un-primed substrate (e.g., the intumescent composition is applied directly onto the substrate.). Some advantages of a primer are corrosion inhibition and enhanced adhesion to the substrate. The primer is preferably non-aqueous, and more preferably an epoxy primer. Similarly, a substrate coated with an intumescent composition of the present disclosure may further be coated with a top coat on top of the intumescent composition. A top coat can provide additional durability to physical or environmental challenges. In particular topcoats can provide protection against abrasion, impact, chemicals, water, temperature extremes and sunlight.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

In Examples 1-3, new wide flange W8×28 columns, 16 inches high, were used. The steel surfaces were pre-treated with acetone (e.g., wiping with acetone). The surfaces were allowed to dry, and then all surfaces of the columns were uniformly trowel-coated with a layer of a commercially available epoxy intumescent product, NanoChar from Intumescent Associates Group. To each column, about 1900 grams were applied in the coating. The depth of the layer was approximately 4.5 mm. Next, either no mesh was used (Example 1), a mesh was used and embedded using known techniques (Example 2), or a mesh was used and applied using the method as described in the present disclosure (Example 3). To each column, a second coat of epoxy intumescent, identical to the first, was then applied over the mesh in each example.

The mesh used in these examples was a Zoltek PX30FS08X4-COAT (Panex 30: Scrim Fabric 8×4 Coated) mesh.

After allowing the coatings to fully cure for four or more days at 120° F., the columns were cooled and tested in a high temperature furnace. The time/temperature profile of the furnace followed the UL 1709 standard, except that 2000° F. was reached in 30 minutes, instead of the 5 minutes as specified in UL 1709.

### Example 1

### No Mesh

In this example, no mesh was used between the first and second layers of epoxy intumescent. Twenty six minutes into the furnace test, the char had split apart at all four flange tips and steel substrate was seen. The test was halted at 60 minutes, at which time the char had also pulled away from the steel on the top half of the outer flanges. This demonstrated the poor performance in the absence of mesh.

### Example 2

### Control

In this example, mesh was embedded into the first layer of epoxy intumescent prior to applying the second layer of epoxy intumescent, approximately 3 hours after application of the first layer. A piece of mesh, 16″ high, was wrapped around each flange tip starting at the corner between the web and the inner flange and extending around the flange tip and 2.5″ on the outer flange. This left a 1.5″ strip without mesh down the middle of each outer flange. The first layer of epoxy was not fully cured at the time the mesh was applied. Penetration of the mesh into the partially-cured epoxy was accomplished with pressure supplied by an acetone-soaked “paint-type” roller. After additional curing of the epoxy, the second coat of epoxy intumescent was applied.

The furnace test was run for 60 minutes, during which time the outer layer of char split at the flange tips, but the lower layer was held together by the mesh. No steel was exposed, and the char remained on the column in all areas. This was a control run to demonstrate the expected (good) performance with the mesh embedded in the epoxy intumescent. No deleterious effects were found from employing the method of the present disclosure for mesh attachment relative to the conventional “embedment” technique.

### Example 3

### Adhesive Composition and Method

The procedure of Example 2 was repeated, but the mesh was not embedded into the epoxy intumescent. The first layer of epoxy intumescent was allowed to cure for the normal amount of time prior to application of the second layer, but prior to application of this second layer, the mesh was attached as follows. Adhesive (Loctite, 300 Heavy, from Henkel Corporation, One Henkel Way, Rocky Hill, Conn. 06067) was quickly sprayed over all surfaces except for the web. Each area was done with two quick passes of approximately 0.5 seconds each in duration, with the spray tip approximately six inches from the substrate. After waiting between one and two minutes, the mesh was patted on by hand, followed by application of the second layer of epoxy intumescent. No organic solvent was needed because the use of a solvent-soaked “paint” roller was eliminated.

The furnace test was run for 60 minutes, during which time the outer layer of char split at the flange tips, but the lower layer was held together by the mesh. No steel was exposed, and the char remained on the column in all areas. This demonstrated that the performance with the mesh anchored by adhesive performed the same as mesh embedded in the epoxy intumescent. No deleterious effects were found from employing the method of the present disclosure for mesh attachment relative to the conventional “embedment” technique.

In Examples 4-5, new wide flange W10×49 columns, 48 inches high, were used. The steel surfaces were pre-cleaned by wiping with acetone. The surface was then primed with a two-part epoxy paint, e.g., Macropoxy 646 from Sherwin Williams, and allowed to dry. The surfaces were then uniformly trowel-coated with two coats (i.e., two layers) of a commercially-available epoxy intumescent product, NanoChar from Intumescent Associates Group. To each column, about 8400 grams were applied in each coating. The depth of each coating was approximately 5.5 mm. Next, a mesh was used and embedded using known techniques (Example 4) or a mesh was used and applied using the method as described in the present disclosure (Example 5). A third coat of epoxy intumescent, identical to the first two, was then applied over the mesh in each example.

The mesh used in these examples was a Zoltek PX30FS08X4-COAT (Panex 30: Scrim Fabric 8×4 Coated) mesh.

After allowing the coatings to fully cure over 14 days at 70-100° F., the columns were cooled and tested in a high temperature furnace at Underwriters Laboratories in Northbrook, Ill. The time/temperature profile of the test followed the UL 1709 standard.

### Example 4

### Control

In this example, mesh was embedded into the second layer of epoxy intumescent prior to applying the third layer of epoxy intumescent. Two pieces of mesh, 48″ high, were wrapped around two flange tips starting at a corner between the web and an inner flange and extending around the flange tip and over the outer flange, around a second flange tip and over the adjacent inner flange to the corner between the web and the inner flange. The second layer was partially cured at the time the mesh was applied. Penetration of the mesh into the uncured epoxy was accomplished with pressure supplied by an acetone-soaked “paint-type” roller. After the epoxy had further cured around the mesh, the third coat of epoxy intumescent was applied.

The furnace test was run for 147 minutes at which time the average temperature of the column reached 1000° F. During this time, the outer layer of char split at the flange tips, but the lower layers were held together by the mesh. No steel was exposed, and the char remained on the column in all areas. This was a control run to demonstrate the expected (good) performance with the mesh embedded in the epoxy intumescent.

### Example 5

### Adhesive Composition and Method

The procedure of Example 4 was repeated, but the two pieces of mesh were not embedded into the epoxy intumescent. They were wrapped around each flange tip starting at a corner between the web and an inner flange and extending around the adjacent flange tip and 4″ on the outer flange. This left a 2″ strip without mesh down the middle of each outer flange. The first layers of epoxy intumescent were allowed to cure for the normal amount of time prior to application of the third layer, but prior to the application of this third layer, the mesh was attached as follows. Adhesive (Loctite, 300 Heavy, from Henkel Corporation, One Henkel Way, Rocky Hill, Conn. 06067) was quickly sprayed over all surfaces except for the web. Each area was done with two quick passes of approximately 0.5 seconds each in duration, with the spray tip approximately six inches from the substrate. After waiting between one and two minutes, the mesh was patted on by hand on the second layer, followed by application of the third layer of epoxy intumescent.

The furnace test was run for 147 minutes at which time the average temperature of the column reached 1000° F. During this time, the outer layer of char split at the flange tips, but the lower layers were held together by the mesh. No steel was exposed, and the char remained on the column in all areas. This demonstrated that the system with the mesh anchored by adhesive performed the same as mesh embedded in the epoxy intumescent. Additionally, it was found that minimal, if any, organic solvent was emitted because the use of a solvent-soaked “paint” roller was eliminated. No deleterious effects were found from employing the method of the present disclosure for mesh attachment relative to the conventional “embedment” technique.

While this disclosure has been particularly shown and described with reference to example embodiments thereof, it will be understood by those skilled in the art that various changes in form and details may be made therein without departing from the scope of the invention encompassed by the appended claims.

We claim:

1. An intumescent composition comprising:
(i) a first epoxy resin layer having a top side and a bottom side, and including intumescent material;
(ii) a one-part adhesive in contact with the top side of the first epoxy resin/intumescent layer;
(iii) a mesh in contact with the top side of the adhesive; and
(iv) a second epoxy resin layer in contact with the top side of the first resin layer, mesh, or adhesive, and including intumescent material;
wherein the first and second epoxy resin/intumescent layers swell as a result of heat exposure.

2. The intumescent composition of claim 1, wherein the intumescent material is selected from the group consisting of ammonium polyphosphate, melamine pyrophosphate, ethylenediamine phosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides, and tris(dimethylaminomethyl)phenol.

3. The intumescent composition of claim 1, wherein the adhesive is comprised of a rubbery solid and an organic solvent.

4. The intumescent composition of claim 1, wherein the adhesive is a polymer contained in a water-based emulsion.

5. The intumescent composition of claim 1, wherein the adhesive is non-continuous and the first and second resin layers are in contact.

6. The intumescent composition of claim 1, wherein the mesh includes carbon, glass, refractory inorganics, or mixtures thereof.

7. The intumescent composition of claim 1, wherein the adhesive is selected from the group consisting of a rubbery solid, a polymer or a water-based emulsion.

8. The intumescent composition of claim 1, wherein adhesive is in the form of a non-continuous layer.

9. An article comprising a substrate with edges or sides, wherein the substrate is coated with an intumescent composition of claim 1.

10. The article of claim 9, wherein the substrate includes steel.

11. The article of claim 9, wherein the substrate is an I-beam, a wide flange column, a round column or a rectangular column.

12. A method comprising:
(i) applying a first epoxy resin layer including intumescent material to a substrate;
(ii) applying a one-part adhesive to the first resin layer;
(iii) applying a mesh to the adhesive-covered first resin layer; and
(iv) applying a second epoxy resin layer including intumescent material to the mesh to form an intumescent composition;
wherein the intumescent materials swell as a result of heat exposure.

13. The method of claim 12, wherein the adhesive is applied by a roller, by a brush, or is spray-applied.

14. The method of claim 12, wherein the first resin layer is substantially cured prior to the application of the adhesive.

15. The method of claim 12, wherein the adhesive is comprised of a rubbery solid and an organic solvent.

16. The method of claim 12, wherein the adhesive is a polymer contained in a water-based emulsion.

17. The method of claim 12, wherein the adhesive is non-continuous and the first and second resin layers are in contact.

18. A method comprising:
(i) applying a first epoxy resin layer including intumescent material to a substrate;
(ii) applying a one-part adhesive to a mesh;
(iii) applying the mesh to the first resin layer; and
(iv) applying a second epoxy resin layer including intumescent material to the first resin layer, mesh, or both, to form an intumescent composition;
wherein the intumescent materials swell as a result of heat exposure.
